(19) United States
(12) Patent Application Publication
(10) Pub. No.: US 2017/0023470 A1
(43) Pub. Date: Jan. 26, 2017

(54) WETTING DETECTION WITHOUT MARKERS

(71) Applicant: KONINKLIJKE PHILIPS N.V., Eindhoven (NL)

(72) Inventors: PATRICK BRONNEBERG, EINDHOVEN (NL); ROLAND ANTONIUS JOHANNES GERARDUS SMITS, EINDHOVEN (NL); SYTSKE FOPPEN, EINDHOVEN (NL); FRANCISCUS HENDRIKUS VAN HEESCH, EINDHOVEN (NL); HONG LIU, EINDHOVEN (NL); ALBERT HENDRIK JAN IMMINK, EINDHOVEN (NL)

(21) Appl. No.: 15/118,018

(22) PCT Filed: Feb. 12, 2015
(86) PCT No.: PCT/EP2015/052989

§ 371 Date: Aug. 10, 2016

(30) Foreign Application Priority Data
Feb. 13, 2014 (EP) 14155025.1

(51) Int. Cl. G01N 21/41; G01N 27/12; G01N 21/552

(52) U.S. Cl. CPC G01N 21/4133; G01N 21/552; G01N 27/12

(57) ABSTRACT

The present invention relates to a method for evaluating the start of an assay in a fluidic chamber, wherein said start of the assay is based on the dissolving of a reagent in a region of interest in said fluidic chamber. The method may be based on the detection of an optical effect in the region of interest caused by the dissolving of the reagent, comprising the steps: obtaining an optical signal from one or more sub-sections of said region of interest; processing said optical signal to a Boolean signal; and defining the start of the assay based on said Boolean signal. The present invention also relates to a method for evaluating the start of an assay comprising an electrical detection of a change in the conductivity or permittivity of fluid due to the dissolving of reagent as mentioned above. Furthermore, the invention relates to a program element or computer program for evaluating the start of an assay and to an evaluation system for determining the start of an assay, comprising a computer processor, memory, and (a) data storage device(s), the memory having programming instructions to execute such a program element or computer program.

### FIELD OF THE INVENTION

The present invention relates to a method for evaluating the start of an assay in a fluidic chamber, wherein said start of the assay is based on the dissolving of a reagent in a region of interest in said fluidic chamber. The method may be based on the detection of an optical effect in the region of interest caused by the dissolving of the reagent, comprising the steps: obtaining an optical signal from one or more sub-sections of said region of interest; processing said optical signal to a Boolean signal according to the presence of said optical effect; and defining the start of the assay based on said Boolean signal. The present invention also relates to a method for evaluating the start of an assay comprising an electrical detection of a change in the conductivity or permittivity of fluid due to the dissolving of reagent as mentioned above. Furthermore, the invention relates to a program element or computer program for evaluating the start of an assay and to an evaluation system for determining the start of an assay, comprising a computer processor, memory, and (a) data storage device(s), the memory having programming instructions to execute such a program element or computer program.

### BACKGROUND OF THE INVENTION

The analysis of blood, e.g. the performance of immune-assays on blood samples, is an activity which is typically carried out in a hospital, or a laboratory by a medical professional. However, due to improvements in the development of mobile analysis devices, e.g. comprising disposable cartridge elements, and the advent of suitable telemedicine solutions, home or abroad monitoring of parameters of bodily fluids has become feasible. Accordingly, patients themselves—without the direct assistance of medical professionals—, or medical professional outside of hospital or laboratory environments can use integrated devices in order to check parameters of bodily fluids on a regular, e.g. weekly or daily basis. Corresponding results of immuno-assays may be analyzed immediately, and/or can be transmitted to healthcare professionals allowing for telemedical or direct intervention.

In order to become suitable for such an approach home monitoring or mobile devices have to be robust and as fail safe as possible. It should, in particular be avoided to produce false results, or to force the patient to repeat measurement steps. A typical problem, which frequently occurs during the handling of such devices is their failing due to an incorrect definition of the starting point of an assay, e.g. the point at which the bodily fluid actually enters a fluidic chamber, since such starting point is typically used for the triggering of subsequent steps, in particular non-molecular steps such as mechanic or magnetic actuation or the optical detection of assay results.

In WO 2009/060358A2 the dispersion of particles into solution is measured by means of FTIR (frustrated total internal reflection). However, the approach is not optimal since it requires beads to be on the surface of the cartridge. This solution is not optimal for inhibition assays since binding can take place during processing. Furthermore it causes a high blank due to a-specific binding.

In consequence there is a need for the development of a method which allows to accurately evaluate the start of an assay, in particular of an immune-assay.

### OBJECTS AND SUMMARY OF THE INVENTION

The present invention addresses these needs and provides a method for evaluating the start of an assay in a fluidic chamber, wherein said start of the assay is based on the dissolving of a reagent in a region of interest in said fluidic chamber. In one aspect of the invention, these needs are specifically addressed by the provision of a method for evaluating the start of an assay in a fluidic chamber, wherein said start of the assay is based on the dissolving of a reagent in a region of interest in said fluidic chamber and wherein said dissolving causes an optical effect to occur in said region of interest, comprising the steps: obtaining an optical signal from one or more sub-sections of said region of interest; processing said optical signal to a Boolean signal according to the presence of said optical effect; and defining the start of the assay based on said Boolean signal. It was, in particular, found by the inventors that a phenomenon observed during FTIR imaging of a fluidic chamber of a device after wetting, namely the development of a dark stain or “black blob” can reproducibly be generated and be used as basis for an optical signal indicating the presence of sample fluid in the fluidic chamber. The physical phenomenon causing the “black blob” may be the dissolving of a buffer, e.g. containing sucrose, which may cover the beads on the cartridge laminate. On dissolving, the bead buffer typically drips down to the cartridge surface causing a dark stain in the FTIR image. In the FTIR image, the “black blob” may appear very gradually until it is a dark stain in the centre of the reaction chamber and then gradually disappears again. On the basis of optical signals obtained from the region of interest in which the staining occurs the inventors could develop an algorithm which is able to accurately detect this feature based on a real-time region analysis of the FTIR image. This allows for a very fast and reliable determination of assay start points even under non-optimal conditions such as tilting of the device, user interference such as a touching of the device which may cause a movement of the FTIR image. In a further aspect of the invention, these needs are specifically addressed by the provision of a method for evaluating the start of an assay comprising electrical detection of a change in the conductivity or permittivity of fluid due to the dissolving of reagent as mentioned above.

In a preferred embodiment of the invention said assay may be performed in a fluidic chamber of a microfluidic cartridge. In a particularly preferred embodiment, said cartridge may be part of an in-vitro diagnosis system.

In a further preferred embodiment the reagent as mentioned above is sucrose.

In a particularly preferred embodiment of the present invention said definition of the start of the assay may trigger the start of magnetic actuation in the fluidic chamber and/or of a measurement of assay results. It is particularly preferred that said measurement is an optical detection such as FTIR imaging.

In a preferred embodiment of the optical aspect of the present invention the step of processing the optical signal comprises (i) normalizing said optical signal; (ii) comparing the normalized signal of (i) with a threshold value, and (iii) defining the start of the assay when said threshold value is surpassed.

In yet another preferred embodiment of the optical aspect of the present invention said optical effect is a change in the refractive index of fluid due to the dissolving of said reagent, e.g. sucrose, in said region of interest.

In yet another preferred embodiment of the optical aspect of the present invention, said region of interest may be sub-divided into 3 or more overlapping sub-sections.

Particularly preferred is a sub-division into a grid of 3×3 sub-sections. In a further particularly preferred embodiment, each two overlapping sectors may show an overlap of at least 50%.

In another preferred embodiment of the optical aspect of the present invention said obtaining of an optical signal comprises recording of an FTIR image.

In yet another preferred embodiment the method optical as described above may additionally comprise a step of removing spike signals subsequent to the step of obtaining an optical signal from a sub-section of a region of interest in which the assay is performed. It is particularly preferred that said step is performed by using a median filter.

In a further preferred embodiment of the optical aspect of the present invention the method as defined herein above additionally comprising a step of combining signals subsequent to the step of normalizing said optical signal, wherein said combination of signals comprises a selection of the sub-section of the region of interest in which the highest signal is recorded per timeframe and a linking of these highest signals.

In yet another preferred embodiment of the optical aspect of the invention the method as defined herein above may additionally comprise a step of calculating a trend change subsequent to the step of combining signals, wherein said calculation is based on a comparison of the combined signal with a smoothed version of the signal.

In another aspect the present invention relates to a program element or computer program for evaluating the start of an assay and optionally for triggering the start of magnetic actuation in the fluidic chamber and/or a measurement of assay results, which when being executed by a processor is adapted to carry out the optical signal processing steps of the optical methods as defined herein above, or adapted to carry out and/or control electrical detection of a change in the conductivity or permittivity of fluid of the method as defined herein above.

In yet another aspect the present invention relates to an evaluation system for determining the start of an assay, comprising a computer processor, memory, and (a) data storage device(s), the memory having programming instructions to execute a program element or computer program as defined above.

### BRIEF DESCRIPTION OF THE DRAWINGS

FIG. 1 shows an example of a device comprising a cartridge which may be analysed on the basis of FTIR (frustrated total internal reflection) imaging according to a specific embodiment of the invention.

FIG. 2 depicts the basepart of a cartridge comprising the reaction chambers for immunoassays according to a specific embodiment of the present invention.

FIG. 3 shows the wetting of a fluidic chamber and the appearance of a “black blob”, i.e. a darkening of the chamber after wetting, according to a specific embodiment of the present invention.

FIG. 4 depicts an FTIR image of the reaction chambers. Regions to be monitored are shown with a white grid.

FIG. 5 depicts an FTIR image of the reaction chambers including the optical phenomenon of a “black blob”, i.e. a darkening of the chamber after wetting.

FIG. 6 provides an overview of algorithmic steps to be performed in order to arrive at a decision on the wetting status of the region of interest according to a specific embodiment of the present invention.

FIG. 7 provides a schematic overview of overlapping sub-sections 1 to 9 of the region to be monitored.

FIG. 8 shows the darkening of several sub-sections of the area of interest in the reaction chamber after wetting in the form of a signal detected over time.

FIG. 9 shows the signals depicted in FIG. 8 after a spike or noise removal according to an embodiment of the present invention.

FIG. 10 depicts a normalized signal of all regions detected according to an embodiment of the present invention.

FIG. 11 shows a combined signal of the normalized signals provided in FIG. 10 according to an embodiment of the present invention.

FIG. 12 depicts the modifications to a signal as shown in FIG. 11 during trend change detection. The trend change detection is performed in 3 steps, which finally results in modified signal (“trend change signal”) shown as “step 3” in FIG. 12.

FIG. 13 shows the smoothed signals of FIG. 12 after filtering according to the present invention in comparison to a threshold value. The threshold is indicated by the horizontal dotted line. The resulting detection point, i.e. the point which indicates the starting of the assay and thus triggers subsequent assay activities according to specific embodiments of the present invention, is indicated by a vertical dotted line.

FIG. 14 shows the trend change signal of FIG. 13 (step 3) alone in comparison to a threshold value.

FIG. 15 provides an overview over a framework for developing, testing and tuning wetting algorithms.

### DETAILED DESCRIPTION OF THE EMBODIMENTS

The present invention relates to a method for evaluating the start of an assay in a fluidic chamber.

Although the present invention will be described with respect to particular embodiments, this description is not to be construed in a limiting sense.

Before describing in detail exemplary embodiments of the present invention, definitions important for understanding the present invention are given.

As used in this specification and in the appended claims, the singular forms of “a” and “an” also include the respective plurals unless the context clearly dictates otherwise.

In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%.

It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only.

Furthermore, the terms “first”, “second”, “third” or “(a)”, “(b)”, “(c)”, “(d)”, “(i)”, “(ii)”, “(iii)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In case the terms “first”, “second”, “third” or “(a)”, “(b)”, “(c)”, “(d)”, “(i)”, “(ii)”, “(iii)” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below.

It is to be understood that this invention is not limited to the particular methodology, protocols, reagents, measurement techniques, algorithms etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

As has been set out above, the present invention concerns in one aspect a method for evaluating the start of an assay in a fluidic chamber, wherein said start of the assay is based on the dissolving of a reagent in a region of interest in said fluidic chamber.

The term “fluidic chamber” as used herein refers to a receptacle or container structure, which allows or is suitable for the performance of molecular reactions in a liquid, e.g. aqueous, environment. The fluidic chamber may, in one embodiment, be formed within a chamber body, e.g. between a first surface and a second surface. The chamber may, in further specific embodiments, be equipped with one or more inlet and/or outlet elements, it may comprise one or more specific surfaces, e.g. reactive surfaces or surfaces with specific functionality. In further embodiments, it may be connected with additional regions or zones such as a reaction zone, a washing zone, a mixing zones, a waiting zone, a measurement zone, a waste zone, a reservoir zone, a recollection and regeneration zone or a recollection or regeneration zone etc. or any sub-portion or combination thereof. Such zones may, in certain embodiments, also be part of the fluidic chamber. In specific embodiments it may comprise reservoirs and repositories for reagents, beads, liquids, fluids, chemicals, ingredients, any other entity to be used within the device. It may further be connected via tubes or joints with other elements or zones of a device, and/or with the exterior, e.g. in form of a capillary tube which allows to transport a bodily fluid to the chamber, preferably blood. In specific embodiments, the fluidic chamber may be connected and/or be in fluidic communication to a second fluidic chamber.

The fluidic chamber is preferably equipped with or comprise elements allowing a reaction, e.g. a molecular interaction such as an immunologic interaction, to take place in said entity. To be suitable for allowing a reaction one or more parameters may be set or adjusted in the fluidic chamber. For example, the temperature in a reaction zone may be adjusted to a suitable value known to the person skilled in the art. The value may largely depend on the target molecule to be selected and the reaction or interaction type taking place and may differ in dependence of the reactant type, the reaction category, the envisaged speed, reaction end point considerations and further parameters known to the person skilled in the art. Elements allowing a reaction to take place may be substrates, arrays of chemical, biochemical, biological or other entities, catalyst etc. Furthermore, the fluidic chamber may be composed of regions suited for measurement or movement activities such as actuation of elements, e.g. it may comprise a moveable surface allowing for a reduction of the enclosed space, and/or it may comprise electrically conductive zones or capacitor zones etc. and/or it may comprise one or more transparent surfaces allowing an optical detection and/or it may be equipped with magnetic units allowing for the actuation or movement of magnetic entities such as magnetic beads. In certain embodiments the dimension and/or form of the reaction may be adapted to one of the above indicated functions. In a further embodiment the fluidic chamber may additionally or alternatively comprise one or more detection zones. This zone may be identical to the other zones, or may be separated from the other zones, e.g. the reaction zone or the mixing zone etc. A detection zone within the meaning of the present invention may comprise sensor or detector elements, e.g. for electrically or optically detecting reaction products, reaction results or for checking whether reaction steps have been concluded or not. These zones may comprise, for example, electrically conductive zones or capacitor zones etc. or they may comprise one or more transparent surfaces allowing an optical detection, e.g. of reaction results such as, for example, the performance or intensities of labeling reaction etc.

In further embodiments of the invention the fluidic chamber may additionally or alternatively be connected to heating modules or regulating units for controlling and/or regulating the temperature. It may, for example, comprise a heating zone wherein the temperature may be kept constant at a desired value, or may be set to a desired value in dependence of a reaction type. In further embodiments the fluidic chamber may additionally or alternatively be connected to cooling modules, e.g. a cooling zone wherein the temperature may be kept constant at a desired value, or may be set to a desired value in dependence of a reaction type. Such zones may further also be equipped with suitable sensor elements allowing the measurement of temperature changes or temperature gradients.

Additionally or alternatively, the fluidic chamber may be connected to units, elements or equipment allowing to change further parameters such as the presence of charged entities, the presence of ions, or may convey mechanical or shearing forces etc. For example, the element(s) may be suited to establish an electric or electrophoretic current, the element(s) may be suited to provide a specific pH or a specific presence of chemical or physical entities, e.g. the presence of certain acids, salts, solvents etc. and/or the element(s) may be suited to provide a strong medium movement. Any of the above mentioned additional facilities may be available in a device which comprises said fluidic chamber, e.g. a cartridge. In further specific embodiments the fluidic chamber may additionally or alternatively be combined with modules allowing the detection of the presence or absence of reagents.

In specific embodiments, the fluidic chamber may be part of a microfluidic device, i. e. a device allowing the precise control and manipulation of fluids that are constrained to small, preferably sub-millimeter scales. Typically, a microfluidic device implements small volumes, e.g. in the range of μl, nl, or pl and/or it may implement an small overall size. Furthermore, a microfluidic device may consume a lower amount of energy. In a microfluidic device effects such as laminar flow, specific surface tensions, fast thermal relaxation, the presence of electrical surface charges and diffusion effects may be implemented and/or used. Furthermore, the microfluidic device may comprise an electronic or computer interface allowing the control and manipulation of activities in the device, and/or the detection or determination of reaction outcomes or products.

In another specific embodiment of the present invention said fluidic chamber or said microfluidic device may be provided in the form of a cartridge, e.g. as a microfluidic cartridge or integrated microfluidic cartridge. The cartridge may comprise all necessary connections, zones and, optionally, also necessary ingredients and be provided as a chamber or container like form. The cartridge may, for example, be entirely closed, or partially closed allowing the introduction of samples, ingredients etc. via resealable inlets. The cartridge may further be equipped with alignment structures for detection devices or readers.

Accordingly, the cartridge may have a configuration which fits into a detection device or reader, which may provide an opening or receptacle structure for the cartridge. The detection device or reader and the cartridge may preferably form an in vitro-diagnosis system, e.g. being adapted to in vitro detection of molecules. The detection device or reader may contain openings or entrance holes in order to allow insertion of said cartridge. Accordingly, both elements, i.e. a reader and a cartridge may be connected in a push fit fashion, e.g. as cradle and plug-in module. The reader may accordingly be provided with opening or receptacle structures, allowing the connection or introduction of a cartridge. The physical separation of both entities or elements of the system provides the advantage that the reader may be used for multiple analyses, while the cartridge may comprise disposable, non-reusable or non-expensive elements such as chemical reactants or assay components etc. A cartridge according to the present invention is in a specific embodiment thus envisaged as a single use or disposable product.

The term “assay” as used herein refers to a molecular detection or analysis approach which allows determine the presence and/or amount of one or more target substances in sample. The assay may be based on immunologic principle, nucleic acid interactions, receptor-ligand interactions, other non-immunologic binding or interaction principles, or any other biochemical, biological or chemical principle. Preferably, the assay is an immunoassay, i.e. based on the interaction of immune-active substances such as antibodies or antibody-fragments and antigens or antigen-fragments which are bound by said antibodies or fragments thereof In particularly preferred embodiments the assay may be an in vitro diagnostics assay.

In further typical embodiments, the assay may be based, include or require the use of detection particles. The term “detection particle” as used herein means a small, localized object to which can be ascribed a physical property such as volume or mass. In the context of the present invention a detection particle comprises or consists of any suitable material known to the person skilled in the art, e.g. the detection particle may comprise, or consist of, or essentially consist of inorganic or organic material. Typically, a detection particle may comprise, or consist of, or essentially consist of metal or an alloy of metals, or an organic material, or comprise, or consist of, or essentially consist of carbohydrate elements. Examples of envisaged material include agarose, polystyrene, latex, polyvinyl alcohol, silica and ferromagnetic metals, alloys or composition materials. Particularly preferred are magnetic or ferromagnetic metals, alloys or compositions.

Particularly preferred detection particles useful in the present invention are superparamagnetic particles. The term “superparamagnetic” as used herein describes a form of magnetism, which appears in small ferromagnetic or ferromagnetic nanoparticles. It is known in the art that in sufficiently small nanoparticles, magnetization can randomly flip direction under the influence of temperature. The time between two flips is referred to as the Néel relaxation time. In the absence of an external magnetic field, when the time used to measure the magnetization of the nanoparticles is much longer than the Néel relaxation time, the magnetization appears to be in average zero, i.e. in the paramagnetic state. In such a state an external magnetic field is able to magnetize the nanoparticles similarly to a paramagnet. However, the magnetic susceptibility is much larger than those of paramagnets.

In specific embodiments of the present invention, the magnetic particle may be an iron containing magnetic particle. In other embodiments, the magnetic particle may include iron oxide such as Fe₃O₄, or Fe₂O₃, or iron platinum. Also envisaged are alloys with Ni, Co and Cu, or particles comprising these elements. In further embodiments, the magnetic particle may comprise a certain amount of superparamagnetic beads, e.g. 10%, 20%, 30%, 40%, 50%, 60%, 70%, 80%, 90% or more than 90% by weight. Such beads may, for example, comprise en encapsulation with a polymer coating thus providing a bead of a size of around 200 to 300 nm. In preferred embodiments, the material comprised in the magnetic particle may have a saturated moment per volume as high as possible thus allowing to maximize gradient related forces. In further preferred embodiments, the particle material may have specific properties. The material may, for example, be hydrophobic, or hydrophilic. In further specific embodiments the particle is a plastic particle. Examples of plastic detection particles include latex or polystyrene beads, e.g. those commonly used for purification. In yet another embodiment, the particle may be a cell like detection particle, e.g. having a biological or semi-biological structure, which is present in biological systems or having the form and/or function of biological systems or parts of biological systems. Furthermore, a detection particle may essentially behave as a whole unit in terms of its transport and properties. Particles may accordingly be of a symmetrical, globular, essentially globular or spherical shape, or be of an irregular, asymmetric shape or form. The size of a detection particle envisaged by the present invention may ranges between 50 nm and 50 μm. Preferred are detection particles in the nanometer and micrometer range up to several micrometers. In further preferred embodiments the detection particle diameter is larger than 100 nm. The term “diameter” as used herein refers to any straight line segment that passes through the center of the particle and whose endpoints are on the detection particle surface. In case of non-spherical or semi spherical detection particles, the diameter is understood as the average diameter of the largest and shortest straight line segments that pass thought the center of the particle and whose endpoints are on the detection particle surface. Particularly preferred are detection nanoparticles, e.g. detection particles of a diameter of about 100 nm to 10 micrometer, more preferably 100 nm to 3 μm, even more preferably 300 nm to 1000 nm. In a particularly preferred embodiment, the material of the detection particle is a magnetic material. In further particularly preferred embodiments, detection particle is a magnetic nanoparticle. In particularly preferred embodiments of the present invention, the material, or particle, e.g. nanoparticle may be superparamagnetic detection particles, which may, for example, be dispersed in an aqueous solution.

In preferred embodiments, the detection particles may comprise on its surface entities which allow, directly or indirectly, to detect a target analyte. For example, the detection particle may comprise one or more capture or binding entities, which are capable of specifically binding to a target analyte. Also envisaged is the possibility that the detection particle comprises one or more binding entities which are capable or indirectly binding to a target analyte, e.g. via further interactors or intermediate linking molecules etc. In specific embodiments, the detection particle may be coated with or covered by an avidin or streptavidin interactor, or by a biotin interactor. Such molecules may accordingly allow the interaction with biotin or avidin molecules, which might be present on the target analyte, e.g.

via the previous binding of a biotin or avidin labeled antibody or any other biotin or avidin labeled capture entity. Further examples of interaction couples useful as interactor molecules are biotin/avidin, any antibody/antigen couple, e. g. anti FITC, FITC, anti-TexasRed/TexasRed, anti-digoxygenin/digoxygenin, and nucleic acid complementary strands. Further envisaged are any suitable interaction couples known to the skilled person.

The assay may be carried out in suitable environments, for example it may be carried out in environments which are specifically prepared for the performance of the assay. In certain embodiments, the assay may be performed with reagents which have to be introduced or added to a reaction chamber, .e.g. a fluidic chamber as defined above, in order to allow these reagents to react. In preferred embodiments, the assay may be performed with reagents which are already present in the reaction chamber, e.g. fluidic chamber, before a sample is introduced. In case the reagents are already present in the reaction chamber, e.g. fluidic chamber, they may be provided in an inert or dry form. Preferably, the reagents may be provided in a dry form allowing for their activation by contact with an aqueous liquid, e.g. a sample such as bodily fluid.

The term “start of an assay” as used herein refers to the beginning of biochemical, biological or chemical interactions which are to be detected in the assay. The term thus refers, for example, to immunologic or binding interactions between two molecules which may be initiated by the activation or contacting of interactive partners. This interaction may further be assisted or additionally require auxiliary steps, which have to be started at suitable points in time, e.g. in the beginning of the interaction or at specific stages of the interaction in order to allow for an effective performance of the assay. Such auxiliary steps may, for example, be actuation steps which may be required in order to allow for a mixing and/or separation of reagents or molecules involved in the assay. Such auxiliary steps may further be the release or activation of dyes or staining entities, which may be required for the detection of interaction between two molecules, e.g. an antibody and its target. The auxiliary steps may further include measurement steps to be carried out in order to document any interaction results. Such measurement steps may be optical measurement or physical measurement steps. It is particularly envisaged by the present invention to coordinate the chain of reactions which is initiated by a biochemical interaction or contacting between two molecules, e.g. an antibody and its target with auxiliary steps or activities which are required for the effective performance of the assay and which only should be performed after the initiation of the biochemical interactions, but cannot be triggered directly by these biochemical interactions. For these auxiliary steps it is thus important to accurately define the start of the assay by independent means.

According to a central embodiment of the present invention the start of the assay as defined above is based on the dissolving of a reagent in a region of interest in the fluidic chamber. The “reagent” to be dissolved may be or may comprise any suitable chemical entity or molecule or combination of chemical entities or molecules which is required for the performance of the assay. The reagent may, for example, be or comprise a sugar molecule, e.g. a sucrose molecule. The reagent may, in specific embodiments, comprise additional components such as proteins, salts, or buffers. For example, the reagent may comprise a protein such as BSA. In a further embodiment, the reagent may comprise a salt such as KCl. Preferably, the reagent may comprise a protein such as BSA, a sugar such as sucrose and a salt such as KCl. The present invention further envisages variants thereof, e.g. the presence of any other suitable protein, the presence of any other suitable sugar and/or the presence of any other suitable salt. In addition to sugar, salt and/or proteins, the reagent comprise further components, such as buffer ingredients, alcohols, EDTA etc. The reagent may be provided in any suitable form. Preferably, it is provided in a dried form, which allows a dissolving in aqueous media.

In a preferred embodiment, the refractive index of the dissolving reagent may be close to, approximately identical to or identical to the refractive index of the material of the cartridge. Dissolving reagent and/or cartridge material such as plastic material, or metal material or combinations thereof, may be chosen such that a similarity or identity of the refractive index of the dissolving reagent and the material of the cartridge is given. Such a similarity of refractive indices advantageously allows the FTIR to be broken since light may enter deeper into the cartridge and is no longer reflected at its surface.

The term “region of interest” as used herein refers to a portion or zone of the fluidic chamber in which the assay takes place and in which the assay results may be detected. This region of interest may comprise the entire fluidic chamber or a portion thereof

In preferred embodiments the region of interest may have one or more subsections or subdivisions. These sub-sections may typically not be represented by physical boundaries, but merely correspond to geometrically defined areas of the region of interest. In specific embodiments, the sub-sections may be defined by optical or physical marks, e.g. in the background of the fluidic chamber.

For measurement or detection purposes the region of interest may be sub-divided in any suitable number of sub-sections, e.g. 3, 4, 6, 8, 9, 10, 12, 14, 15, 16, 20 or more subsections. These sub-sections may, for example, be provided in the form of a grid within the area of the region of interest. A non-limiting example of such a grid is shown in FIG. 4 or FIG. 7.

Sub-sections of the grid may either overlap or not overlap. In case of a non-overlap it is envisaged that the grid covers the entire region of interest.

In case of an overlap of the sub-sections, such an overlap may be any suitable overlap of the sub-sections. E.g. the overlap may be an overlap between two adjacent sub-sections of the region of interest of about 10%, 20%, 30%, 40%, 50%, 60%, 70%, or 80% or any value in between these values.

Particularly preferred is an overlap of 50% between two sub-sections of the region of interest. In case the region of interest is divided into several subsections, the overlap may be defined for each two adjacent of these sub-sections. In a preferred embodiment, the region of interest may be sub-divided into a grid of about 3×3 sub-sections.

The sub-sections may have any suitable geometric form, preferably be rectangular or quadratic. Also envisaged are circular, semicircular or elliptic sub-sections, or any mixture thereof.

The term “dissolving the reagent” as used herein means that a reagent as define above may be converted from a dried state into a liquid state, .e.g. by being dissolved in aqueous media. In a preferred embodiment of the present invention, the reagent may be dissolved in a sample which enters the fluidic chamber. Alternatively, the dissolving step may be carried out in other liquids present e.g. in reservoirs of chamber or the cartridge or any device comprising the fluidic chamber. Such liquids may, for example, be buffers or aqueous solutions. Also envisaged is a mixture of a sample and such secondary liquids, e.g. in specific mixing zones adjacent to the fluidic chamber or included in a device or cartridge comprising said fluidic chamber. The sample may typically be any bodily fluid. The term “bodily fluid” as used herein refers to whole blood, serum, plasma, tears, saliva, nasal fluid, sputum, ear fluid, genital fluid, breast fluid, milk, colostrum, placental fluid, amniotic fluid, perspirate, synovial fluid, ascites fluid, cerebrospinal fluid, bile, gastric fluid, aqueous humor, vitreous humor, gastrointestinal fluid, exudate, transudate, pleural fluid, pericardial fluid, semen, upper airway fluid, peritoneal fluid, liquid stool, fluid harvested from a site of an immune response, fluid harvested from a pooled collection site, bronchial lavage, and urine. In further embodiments also material such as biopsy material, e.g. from all suitable organs, e.g. the lung, the muscle, brain, liver, skin, pancreas, stomach, etc., a nucleated cell sample, a fluid associated with a mucosal surface, hair, or skin may be tested. For such a testing, the material is typically homogenized and/or resuspended in a suitable buffer solution. In specific embodiments, samples from environmental sources, e.g. water samples, meat or poultry samples, samples from sources of potential contamination etc. may be used. Such samples may also be processed in order to liquefy them, e.g. by homogenization and/or dissolution in a buffer. Such a homogenization and resuspension in a suitable buffer may also be used in case of non-liquid stool samples, e.g. in solid feces samples. In further embodiments bodily fluid or sample material as mentioned herein above may be processed by adding chemical or biological reactants. This may be performed in order to stabilize the sample material, to remove sample components, or to avoid interaction in samples. For example, EDTA or heparin may be used to stabilize blood samples.

It is preferred using blood samples, e.g. plasma, serum or whole blood. Particularly preferred is the use of plasma or whole blood samples.

In a typical scenario the dissolving of a reagent as mentioned above may lead to an optical effect which occurs in the fluidic chamber, e.g. in the part of the fluidic chamber which can be optically analysed or which allows an optical determination of reactions or changes. In a specific embodiment, said dissolving of the reagent may provide a change in the refractive index of fluid, i.e. of the refractive index of the sample, e.g. bodily fluid as defined herein above, which has entered the fluidic chamber. Such a change of refractive index may, for example, be recognizable as “black blob” or change of intensity towards an increased darkness in the region of interest.

According to a central embodiment of the present invention, the occurrence of said optical effect may be detected by obtaining an optical signal from one or more sub-sections of the region of interest as defined herein above. The term “obtaining an optical signal” as used herein means that an image may be obtained according to any suitable approach. For example, an image may be obtained with a camera such as an active-pixel sensors (APS), i.e. image sensors consisting of an integrated circuit containing an array of pixel sensors, each pixel containing a photodetector and an active amplifier. Examples of APS include CMOS sensors and charged couple device (CCD) image sensors.

In a particularly preferred embodiment, the acquirement of an optical signal occurs via optical detection based on normal refraction of light. In typical embodiments, the normal refraction of light, e.g. induced by dissolving of a reagent as defined herein above, may be recognized and recorded by any suitable optical detection equipment. In certain embodiments, the detection and recording may be performed by optical detection based on total internal reflection (TIR) or, more preferably, frustrated total internal reflection (FTIR). Accordingly, optical equipment suitable for the detection of FTIR may be used for the acquirement of optical signals according to the present invention since such equipment may be capable of detecting frustration of total internal reflection, as well as a lack of total internal reflection due to normal refraction of light. For example, a dark stain caused by the dissolving of a reagent as defined herein above may be caused by refraction, thus allowing light to travel further into a fluidic chamber according to the present invention.

As used herein the term “total internal reflection” describes a condition present in certain materials when light enters one material from another material with a higher refractive index at an angle of incidence greater than a specific angle. The specific angle at which this occurs depends on the refractive indices of both materials, also referred to as critical angle and can be calculated mathematically (Snell's law, law of refraction). In absence of detectable elements the light beam from the light source may be totally reflected. If a detectable element is close to the surface or is in contact with the sensor surface the light is said to be frustrated by the element and reflection at that point is no longer total. The signal which may be defined as the decrease of the totally internal reflected signal can be calculated.

The signal is more or less linearly dependent on the concentration of elements on the surface (surface density ñ). The signal can be expressed as:

S=βñ

wherein S is the measured signal change in % and β is a conversion factor from surface density to signal change. In a particularly preferred embodiment, the obtaining of an optical signal comprises recording of an FTIR image as defined herein above. The recording of said image may be performed according to any suitable method. For instance the recording may be performed with a FTIR setup (OMU) with a led, and optical path which goes through the cartridge, a lense system and which ends in a CMOS camera. In specific embodiments, 25 times per second the image from the camera may be processed by an electronics board which calculates properties for regions of interest in the image. In a particularly preferred embodiment, for each region a single value (e.g. an average intensity of the region) may be calculated at 25 fps.

Subsequent to the acquirement of an optical signal of one sub-section of the region of interest or of more than one of these sub-sections as defined herein above, preferably of overlapping sub-sections, the optical signal may be processed. The processing of the signal is primarily referring to an analysis and transformation of said signal or group of signals with the intention to conclude on the presence of said optical effect, i.e. to decide whether said reagent is indeed dissolved in the region of interest or not. This processing may lead to a Boolean signal (0 or 1), i.e. representing a conclusion on the presence of said optical effect. In case the conclusion of the processing step is that there is no optical effect associated with the dissolving of a reagent present, the Boolean signal 0 may be provided, while in case the conclusion of the processing step that there is an optical effect associated with the dissolving of a reagent present, the Boolean signal 1 may be output or provided.

Subsequent to the processing and the provision of a Boolean signal, e.g. 0 or 1, the start of the assay may be defined. Accordingly, if the Boolean signal 0 is output meaning that no optical effect is given according to processing of signals as defined above, there is no indication of a start of the assay. If, on the other hand the Boolean signal 1 is output meaning that an optical effect is given according to the processing of signals as defined above, there is indication of a start of the assay. Such an indication may further be used in order to trigger subsequent events.

Preferably, the definition of the start of an assay as defined above, e.g. due to the presence of an optical effect detected as described above and caused by the dissolving of a reagent in the region of interest of a fluidic chamber, may lead to the start of actuation or movement activities within the fluidic chamber, or within the device comprising said fluidic chamber. Particularly preferred is the start of magnetic actuation within said fluidic chamber. A “magnetic actuation” as used in the context of the present invention is understood as the application of a uniform magnetic field to a sample containing magnetic nanoparticles as defined herein above that have been incubated with a target analyte or molecule to detect. Upon the activation of the field the magnetic nanoparticles may arrange themselves into chains and are free to vibrate and rotate while in close proximity with each other. The magnetic actuation may be used in order to mix particles, to do bound-free separation in order to eliminate non-specific bindings and to generate local up-concentrations of analyte to increase binding speed.

In further embodiments, the definition of the start of an assay as defined above, e.g. due to the presence of an optical effect detected as described above and caused by the dissolving of a reagent in the region of interest of a fluidic chamber, may additionally or alternatively lead to the start of measurements of assay results. This measurement may preferably include the acquirement of suitable images of the fluidic chamber, in particular of the region of interest of said fluidic chamber, or additionally or alternatively of a reference chamber, e.g. a chamber which has the same properties as the fluidic chamber, albeit without assay ingredients, and/or without fluidics equipment. The images may be obtained according to any suitable technique. It is preferred that the images are acquired as FTIR images, in particular in a setup in which the optical signal as defined herein above is also obtained in the form of an FTIR image.

The definition of the start of an assay as defined above, e.g. due to the presence of an optical effect detected as described above and caused by the dissolving of a reagent in the region of interest of a fluidic chamber, may further lead to the triggering of one or more additional activities associated with the assay, e.g. the recording of images obtained, transmission of data, e.g. via telemedical devices, electronic processing of assay results, cleaning or washing steps, use of excitation light, temperature or pH changes, etc.

In a further set of embodiments, the processing of the optical signal to a Boolean signal as mentioned herein above may be performed according to any suitable methods for normalization, background reduction, statistical relevance testing, spike and outlier removal and threshold comparison.

Preferably, the processing may start with data received from one or more sub-sections of the region of interest, preferably two or more overlapping sub-sections of the region of interest. These data may have been obtained from sub-sections which do not overlap or which overlap, e.g. by 10%, 20%, 30%, 40%, 50%, 60%, 70%, or 80% or any value in between these values as defined above.

The data of the sub-sections may be averaged. The averaging may be performed such that for sub-section the intensities of all pixels are reduced to a single value (the average intensity). Subsequently, the averaged data may be processed in order to remove spike or outlier data points which could generate false positive signals. Such removal of spikes or outlier may be performed by using a median filter or any other suitable filter. The term “spike” as used herein refers to a change of signal in a confined, short period of time. This can, for example, be caused by a movement or tilting of the fluidic chamber or cartridge comprising it. If, for referential purposes, the entire detection cycle, e.g. from the dissolving of the reagent until the optical effect is provided in full is assumed to comprise about 800 to 1000 time frames or time units, a spike as defined herein above may comprise or present only during a limited time period of about 1 to 20 time frames. Alternatively, if, for referential purposes, the entire detection cycle, e.g. from the dissolving of the reagent until the optical effect is provided in full is assumed to comprise about 40 seconds, a spike as defined herein above may comprise or present only during a limited time period of up to 2 seconds.

For example, based on the use of a median filter of, e.g., a width of 100 frames, all spikes up to 49 frames (which may be equivalent to a time period of approx. 2 seconds) may be filtered out. Typically, the spike to be filtered out may be defined according to the width of the median filter, e.g. if a spike is less than half of the width of the median filter it may be filtered out. The median filter may be applied continuously, thus suppressing spikes in the signal.

In a further step the signal may be normalized. The normalization may be performed with data optical signal data obtained before the fluidic chamber was used, i.e. before it was filled with fluid such as sample, in particular before a reagent could possibly be dissolved in said fluidic chamber. The normalization may further be based on historical data obtained from different fluidic chambers. In specific embodiments, the normalization is based on data of the same sub-section of the region of interest, which is the basis of the current optical signal. The normalization may, in particular, comprise a subtraction of any of the currently measured optical signal by a background or historical signal. The normalization may be performed continuously, so that data of all frames may be normalized.

The normalization as describe above may advantageously compensate for inhomogeneity in the fluidic chamber before the filling with sample. For example, if the background of the fluidic chamber is non homogenous due to fabrication problems, the normalization may compensate for these differences. Furthermore, if lighting conditions may be different between cartridges of fluidic chambers thus reducing the overall signal obtainable different in different environments, the normalization may add robustness to the analysis. Furthermore, if lighting, material or assay conditions etc. are different between analyzers, normalization may be used in order to compensate for these differences between the analyzers, e.g. providing a threshold value which may be used for several or all analyzers.

Normalization may be performed based on any suitable method. For example, a procedure including subtraction or division by the basis for normalization (offset or gain normalization) may be used. Alternatively, a different procedure might be employed in order to have an adaptive or a static basis for normalization. Preferably, offset normalization with an adaptive basis may be used.

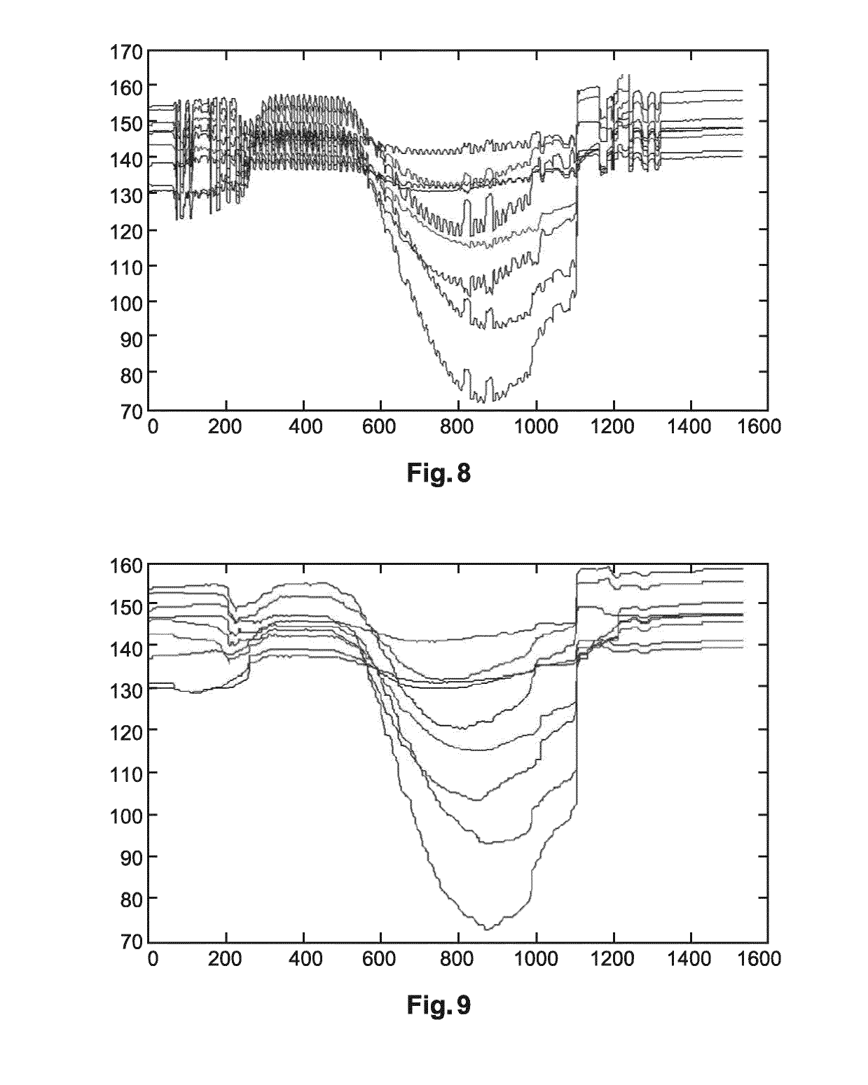

In yet another step for each time frame or conjunction of time frames such as of 100 time frames, or preferably less than 100, 90, 80, 70, 60, 50, 40, 30, 20, 10, 9, 8, 7, 6, 5, 4, 3 or time frames 2 a combination of sub-sections of the area of interest according to the amount of signal, an averaging of all sub-sections of the area of interest, or of several sub-sections of the area of interest, e.g. of the 2, 3, 4, 5, 6 etc. sub-sections with the highest score may be performed. In further specific embodiments, the median value of all sub-sections of the area of interest, or of several sub-sections of the area of interest, e.g. of the 2, 3,4, 5, 6 etc. sub-sections with the highest score may be performed. In yet another specific embodiment, a selection among the sub-sections of the area of interest according to the amount of signal, preferably according to the amount of normalized signal may be performed. Preferably, for each time frame the sub-section of the area of interest with the highest amount of signal in comparison to the status before the dissolving of the reagent or in comparison to a fluidic chamber in which no assay is performed, is selected. This highest amount of signal typically is the darkest signal (e.g. indicated as “minimal signal” or “darkest signal” in FIG. 8). This step assures that the correct sub-section of the area of interest is selected even in cases in which the fluidic chamber or cartridge comprising said fluidic chamber is moved or tilted such that the site where the optical effect occurs may move, e.g. from one sub-section to another one.

In yet another processing step an optical signal of a certain time frame obtained and selected according to a step as defined herein above may be combined with an optical signal of a certain second further or subsequent time frame obtained and selected according to a step as defined herein above may be combined. This combination of selected darkest signals allows for a robust selection of correct sub-sections of the area of interest in cases in which the fluidic chamber or cartridge comprising said fluidic chamber is moved or tilted such that the site where the optical effect occurs may move, e.g. from one sub-section to another one.

In another processing step, a trend change in the signal development may be calculated. The trend change may, for example, be calculated by comparing a signal as obtained in the selection or combination step mentioned herein above with a smoothed version of the signal. The term “smoothed version of the signal” as used herein refers to an average of signals over a time period of about 100 to 400 time frames, preferably of about 300 time frames as defined herein above. In specific embodiments, the time period may also be different, e.g. less than 100 time frames, or more than 400 times frames. In specific embodiments, the trend change may be performed by carrying out the steps of
Step 1: Smoothing of the input signal (IIR filtering)
Step 2: Calculate the trend of the input signal (IIR filtering)
Step 3: Calculate the trend change by subtracting Step1-Step 2

Step 1 and 2 as outlined above may preferably be carried out on the basis of a low-pass IIR filtering. Specifically, a low-pass IIR filter may be based on the difference equation:

y[n]=αy[n−1]+(1−α)x[n]

### Wherein

x[n] is the input at frame ‘n’
y[n] is the output at frame ‘n’
y[n−1] is the output 1 frame before ‘n’
α is a scaling factor in the range 0≦α<1

Filters to be used may preferably have a characteristic that “1/(1−α)” approximates the wavelength (width in frames) of the cutoff frequency of the filter.

It is preferred that in a first step, smoothing of the signal is performed to filter out unwanted artifacts after combining the signals of all regions. This may be done by filtering with a width of about 100 frames, e.g. with

$$( α = 1 - \frac{1}{100} = 0.99 ) .$$

In a specific embodiment in a second step a more extreme smoothing of the signal may be performed to get a prediction of the trend of the signal. This may be carried out by filtering with a width of about 333 frames (so

$$α = 1 - \frac{1}{333} = 0.997 ) .$$

In a further specific embodiment, the trend change may be calculated by subtracting the trend from the smoothed signal, i.e. by calculating how much the smoothed signal differs from the predicted signal, e.g. by the formula

trend change=signalₛₘₒₒₜₕ−signal_{trend}

The above outlined trend change approach, e.g. steps 1 to 3 as explained in detail above or shown in the Examples, may advantageously compensate for static displacement of the cartridge and/or signal drift. In a final processing step the signal, e.g. a smoothed signal as obtained according to a previous processing step, may be compared with a threshold signal. The threshold signal may be defined according to a signals of areas of interest in which no filling process has been initiated, i.e. which show no optical effect. Such reference images and derived signals may be taken alone, or in groups or combination which may be averaged.

In case the threshold is surpassed, this event defines the start of an assay as defined herein above.

In another specific embodiment of the present invention the method for evaluating the start of an assay comprising an electrical detection of a change in the conductivity or permittivity of fluid due to the dissolving of reagent as mentioned above.

The term “electrical detection of a change in the conductivity of fluid” as used herein refers to the measurement of conductivity of a sample in a fluidic chamber, preferably by using two electrodes placed at different positions of the fluidic chamber. For example, these electrodes may be provided in on top oa fluidic chamber, e.g. on top of a cartridge as defined herein. The electrodes may accordingly be in contact with the fluid, e.g. sample in the fluidic chamber. Upon a dissolving of a reagent, e.g. of salts or crystallized entitities, e.g. KCl, ions such as K+ and Cl⁻ may be released into the samle or fluid. Thereby the conductivity of the sample may be changes. Accordingly, a change of conductivity may be sensitized and recorded. Preferably, the sensing may be carried out on the basis of a grounded electrode and a positive electrode with a set voltage, allowing for a measurement of the current flowing through the sample.

The term “electrical detection of a change in the permittivity of fluid” as used herein refers to the measurement of specific permittivity (epsilon r) of a sample in a fluidic chamber by recording changes in the operating frequencies. Preferably, the detection of a change in the permittivity of fluid is performed by using two electrodes, one electrode on top and one electrode on the bottom of the chamber, which are not in contact with the sample in a fluidic chamber. The electrodes may preferably be connected to an oscillator or similar apparatus. Accordingly, the electrodes may act as plates of a capacitor while the sample in between acts as the dielectric. Upon dissolving a reagent in the fluidic chamber, the specific permettivity of the sample changes, e.g. due to the presence of sugars such as sucrose. These changes can accordingly be detected and recorded.

In specific embodiments electrical detection of a change in the conductivity or permittivity of fluid may be performed alone or in combination with optical detection approaches as defined herein above. Advantageously, the electrical detection approach does not require any specific cleaning or removal of optical noise from the fluidic chamber, thus allowing a detection without a clean chamber surface.

In another aspect the present invention relates to a program element or computer program for evaluating the start of an assay and optionally for triggering the start of magnetic actuation in the fluidic chamber and/or a measurement of assay results, which when being executed by a processor is adapted to carry out the optical signal processing steps of the optical methods as defined herein above, or adapted to carry out and/or control dielectric detection of a change in the conductivity of fluid of the method as defined herein above.

In yet another aspect the present invention relates to an evaluation system for determining the start of an assay, comprising a computer processor, memory, and (a) data storage device(s), the memory having programming instructions to execute a program element or computer program as defined above.

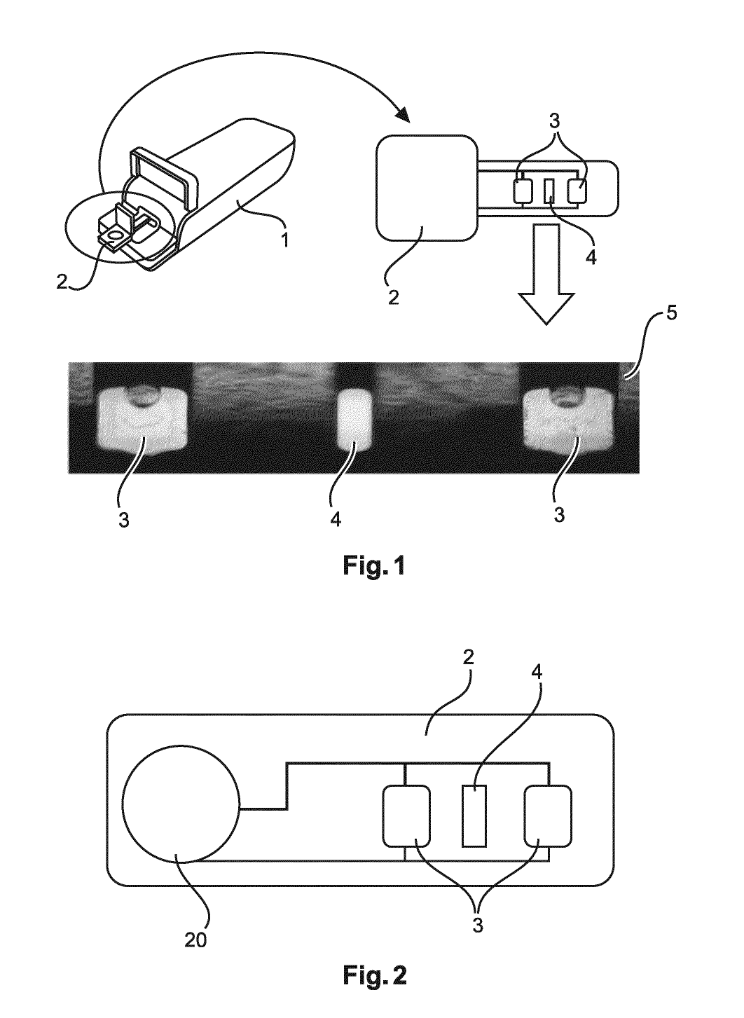

FIG. 1 shows schematically a device 1 comprising a cartridge 2. The cartridge 2 is capable of receiving sample material such as blood samples and may be inserted into the device 1. The cartridge comprises reaction chambers 3 and a reference chamber 4. A frustrated total internal reflection (FTIR) imaging 5 allows detection of alteration in the reaction chambers 3.

FIG. 2 depicts the base part of a cartridge 2 comprising a blood filter 20, reactions chambers 3 and a reference chamber 4.

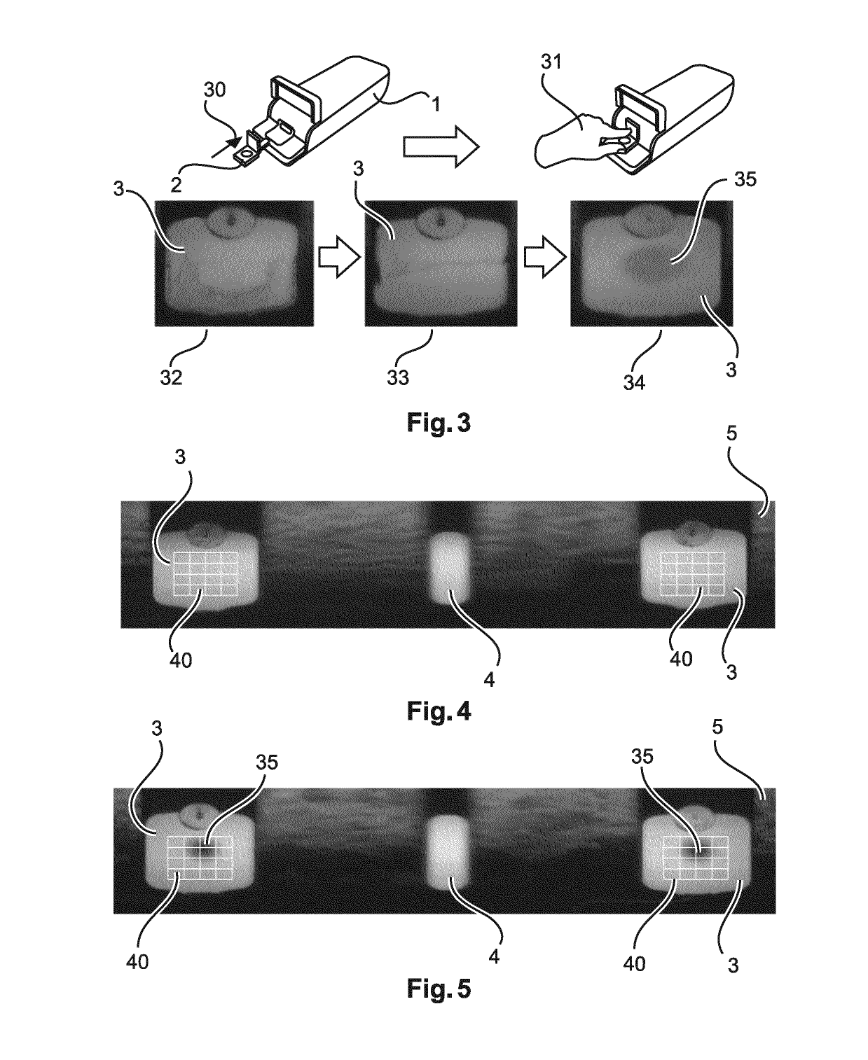

FIG. 3 shows in the upper part the introduction 30 of a cartridge 2 into a device 1. Subsequently a sample, e.g. a blood sample, can be provided to the cartridge 31. In series of cutout pictures 32 to 34 the wetting of a reaction chamber 3 is shown. In situation 32 no sample has arrived, in situation 33 fluid enters the reaction chamber and in situation 34 a “black blob” 35 has appeared due to the wetting, i.e. a darkening of the reaction chamber 3 after wetting occurred.

FIG. 4 depicts an FTIR image 5 of the reaction chambers 3 and the reservoir section 4. Regions to be monitored are shown with a grid 40.

FIG. 5 depicts an FTIR image 5 of the reaction chambers 3 and the reservoir section 4 including regions to be monitored with a grid 40. Within the grid the occurrence of the optical phenomenon of a “black blob” 35, i.e. a darkening of the chamber after wetting can be seen.

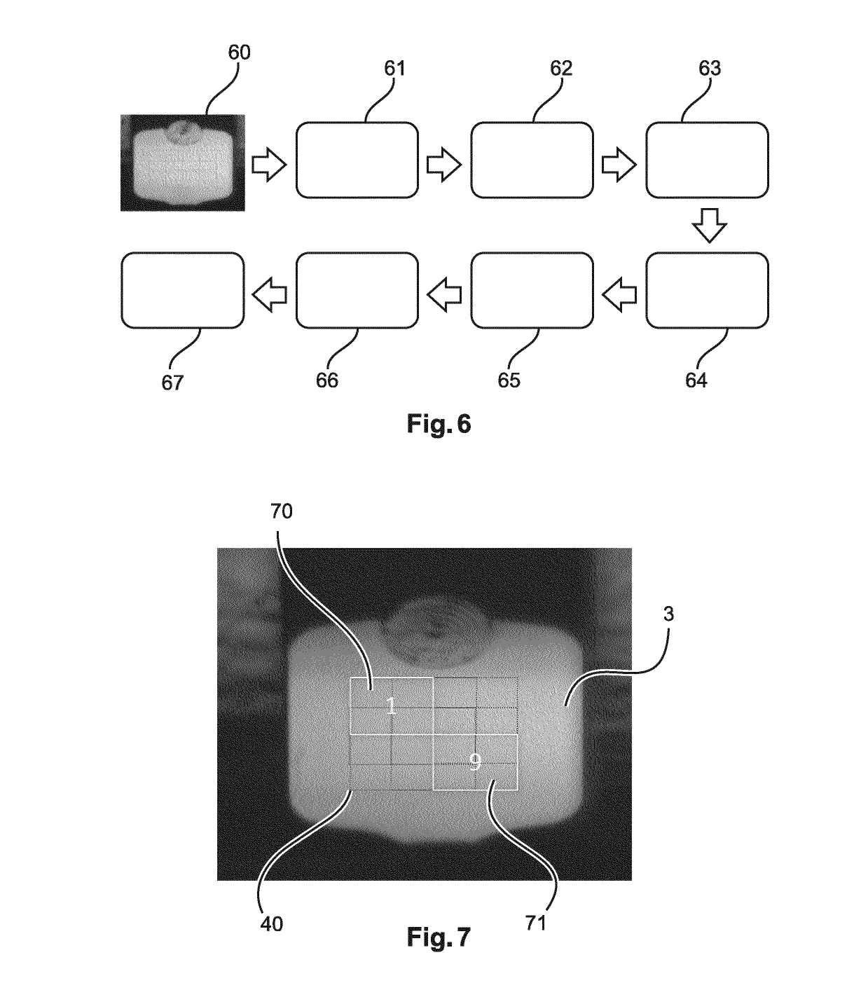

FIG. 6 provides an overview of algorithmic steps to be performed in order to arrive at a decision on the wetting status of the region of interest according to a specific embodiment of the present invention. The series of steps starts with imaging 60 of a reaction chamber 3 including a grid 40. Subsequently 61, region data are obtained. This may be done by using a grid of 3×3 regions per chamber. A 50% overlap of regions and an average of each region may be used. In a next step 61 spikes may be removed. This can be performed by using median filters and a width of 100 frames. Subsequently 62, the signal may be normalized. The normalization may be based on the maximum signal up and until the relevant frame. Later on 64, signals may be combined. In particular, for each frame the region which has the minimal signal (darkest region) is selected. In the next step 65, trend change may be calculated. This can be done by comparing signals to a smoothed version of the signal. Subsequently 66, the signal may be checked against a predefine threshold signal, resulting in wetting detection 67. FIG. 7 provides a schematic overview of overlapping sub-sections 70 of the grid 40 in reaction chamber 3. Shown are the 1⁴ and the 9^{th} sub-section of the grid.

FIG. 15 provides an overview over a framework for developing, testing and tuning wetting algorithms. The series starts with input data 100. These data may be composed of different data types such as lab setup movies, lab setup images, or excel files. The data may already be structured by the performance of alignment activities. The input data are entered into a group of interchangeable processing blocks 150. Among these blocks region data are extracted 110. This may be done on the basis of functions such as Avg and Stdev. Subsequently a first processing block 120, followed by a second processing block 130 may be carried out. This leads to the detection of a wetting frame 140. Finally, the data are validated against annotated information 160. This step allows to detect false positive and false negative signals.

The following examples and figures are provided for illustrative purposes. It is thus understood that the examples and figures are not to be construed as limiting. The skilled person in the art will clearly be able to envisage further modifications of the principles laid out herein.

### EXAMPLES

### Example 1

### Region Definition

The regions for blob detection were defined in a grid of 3×3 regions per chamber. Each region overlaps its neighboring regions by 50%. The grid of regions had a distance of 33 px to the sides of the chamber, and 15 px to the bottom of the chamber and 8 px from the pinning.

The regions were positioned such that the variations in location of the blob due to analyzer orientation are covered, while maintaining enough distance to the edges of the chambers to remain robust against cartridge movement. The size of the regions was adjusted to the typical size of the black blob. Overlapping of the regions was set to 50% so that minimal disturbance of the signal occurs when switching to a different region due to a moving blob.

| Id | X | Y | Width | Height |
|---|---|---|---|---|
| C1.W1 | −548 | −32 | 70 | 40 |
| C1.W2 | −513 | −32 | 70 | 40 |
| C1.W3 | −478 | −32 | 70 | 40 |
| C1.W4 | −548 | −10 | 70 | 40 |
| C1.W5 | −513 | −10 | 70 | 40 |
| C1.W6 | −478 | −10 | 70 | 40 |
| C1.W7 | −548 | 12 | 70 | 40 |
| C1.W8 | −513 | 12 | 70 | 40 |
| C1.W9 | −478 | 12 | 70 | 40 |
| C2.W1 | 407 | −32 | 70 | 40 |
| C2.W2 | 442 | −32 | 70 | 40 |
| C2.W3 | 477 | −32 | 70 | 40 |
| C2.W4 | 407 | −10 | 70 | 40 |
| C2.W5 | 442 | −10 | 70 | 40 |
| C2.W6 | 477 | −10 | 70 | 40 |
| C2.W7 | 407 | 12 | 70 | 40 |
| C2.W8 | 442 | 12 | 70 | 40 |
| C2.W9 | 477 | 12 | 70 | 40 |

An example of the definition of overlapping regions is provided in FIG. 7, which shows the first region No. 1 and the last region No. 9. The regions No. 2 to 8 are not indicated, but can be deduced from the Fig. by moving region No. 1 one square to the right and/or down.

### Example 2

### Algorithm Specification

For blob detection a blob detection algorithm was used, which is composed of a number of steps which were executed in sequence. Each step adds additional robustness and specificity to the algorithm so that wetting can be reliably detected. The steps are clarified by using the signal of a random, noisy experiment as example. FIG. 8 illustrates this signal, which is the result of getting the average signal for each region of a chamber with a region definition specified in Example 1. Typically, the processing is done in real time while the black blob occurs, so only the part of the signal until detection may be available.

### Example 3

### Removal of Spike-Noise

As a first step, for each region the spikes/noise caused by movement of the cartridge was filtered out by using a median filter of width 101. This filter suppresses all high-frequency changes in the region signal without impacting the signal strength of the remaining signal. The result of this removal step is illustrated in FIG. 9, which shows smoothed version of the signal curves as shown in FIG. 8.

### Example 4

### Normalization of Signals

Subsequently a normalization of the signals was performed. This removes differences in a signal caused by the location of the region. Normalization was performed by subtracting the maximum signal up to and until the current frame (‘running maximum’) from the observed signal. In particular, normalization was performed to the maximum value instead of the initial value since the cartridge surface should be clean (white=high signal) after the wavefront and can be dirty (grey=lower signal) before the wave front passes. Also movement to a lighter region may be compensated by this. This typically results in a larger relative signal for the blob.

After normalization the absolute of the signal was calculated. This was done to make the algorithm easier to configure: “greater than” and positive values are easier from a configuration aspect.

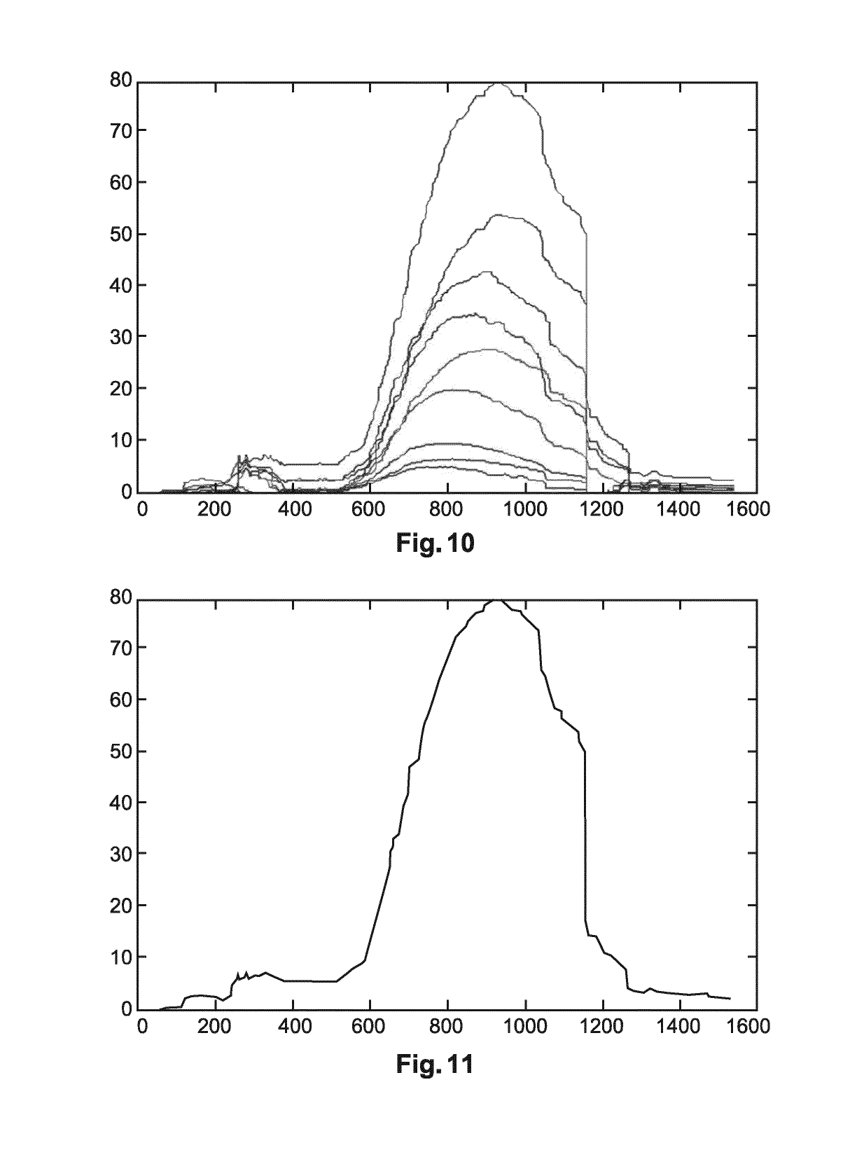

Normalized signals obtained according to this Example are shown in FIG. 10.

### Example 5

### Combination of Signals

In order to result in a single strong signal for the blob, separate signals are combined to a single signal for each chamber. Combining the signals is performed by choosing the region with the maximum signal for each frame. The resulting signal is shown in FIG. 11. Choosing only a single region is due to the fact that the blob will typically be in one region. The approach thus avoids any reduction of signal strength due to an averaging of multiple regions.

The combination of signals further offers the possibility that for each frame a different region might be chosen, thus accounting for the possibility of a movement of the blob due to changes in the orientation of the analyzer, touching events, tilting or the like. Typically, the maximum signal in this case means the region where the blob is darkest.

### Example 6

### Calculation of Trend Change

Based on a combined signal as obtained in Example 5, the onset (start) of the blob could be detected. There may however still be artifacts in the signal which could potentially result in a false positive detection. For example, a signal as shown in frames 300 to 500 of FIG. 11 could potentially trigger a false detection In this case the heightened signal was caused by a displacement of the cartridge (e.g. due to cap closure).

Therefore an additional step was performed to differentiate slow drifts of the signal from a steep rise as caused by the blob. To achieve this, trend change detection was used. The idea of trend change detection is that small and slow changes of the trend are suppressed, so that only large, continuing breaking of the trend will trigger wetting detection. The trend change detection had the following composition:
Step 1: Smoothing of the input signal (IIR filtering)
Step 2: Calculate the trend of the input signal (IIR filtering)
Step 3: Calculate the trend change by subtracting Step1-Step 2

### Low-Pass IIR Filtering

Step 1 and 2 of the trend change detection were based on low-pass IIR filtering. The chosen low-pass IIR filters were based on the following difference equation:

y[n]=αy[n−1]+(1−α)x[n]

In this equation:
x[n] is the input at frame ‘n’
y[n] is the output at frame ‘n’
y[n−1] is the output 1 frame before ‘n’
α is a scaling factor in the range 0≦α<1

These filters have a characteristic that “1/(1−α)” approximates the wavelength (width in frames) of the cutoff frequency of the filter. So given α=0.99, all features in the signal which are less than

$$\frac{1}{1 - 0.99} = \frac{1}{0.01} = 100$$

frames wide are suppressed.

This is an extremely efficient way of filtering out unwanted frequencies since only two multiplications and one addition are needed per frame. This filtering proved to be precise enough for the current algorithm.

### Step 1: Smoothing

In the first step, smoothing of the signal was performed to filter out unwanted artifacts after combining the signals of all regions. This was done by filtering with a width of 100 frames

$$( α = 1 - \frac{1}{100} = 0.99 ) .$$

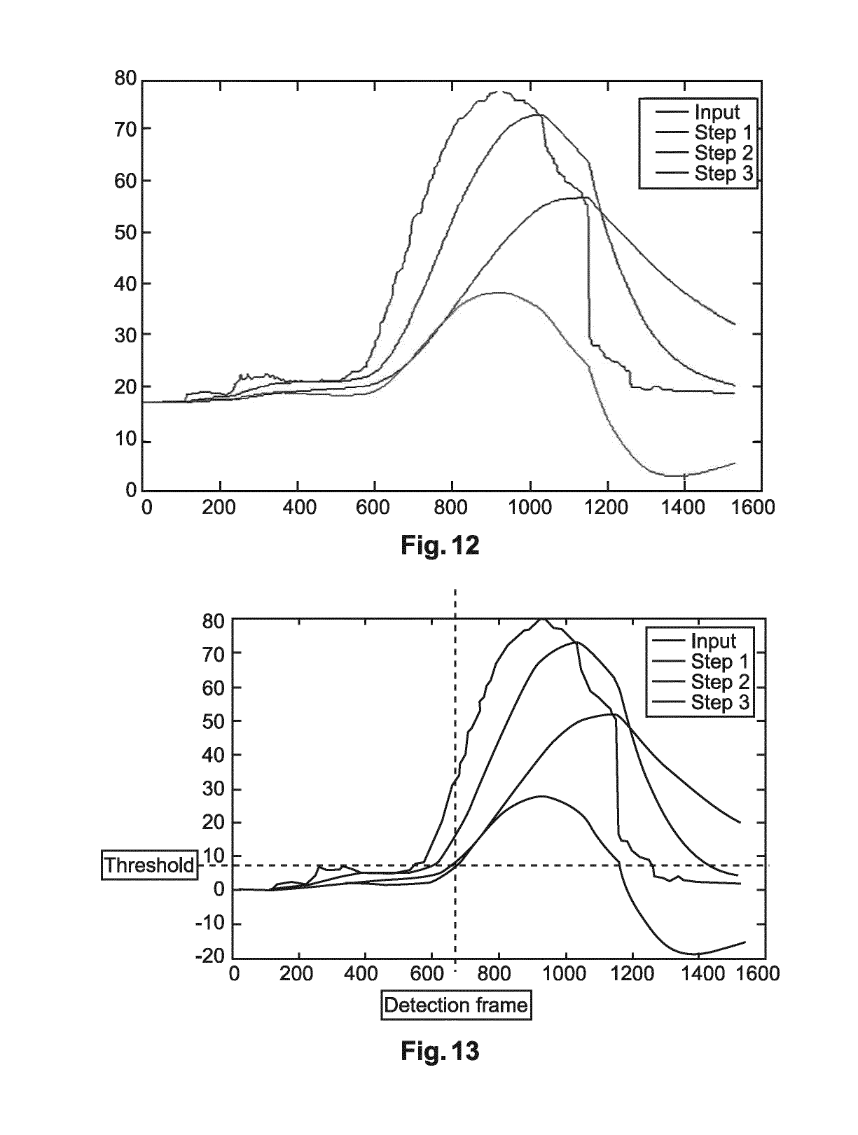

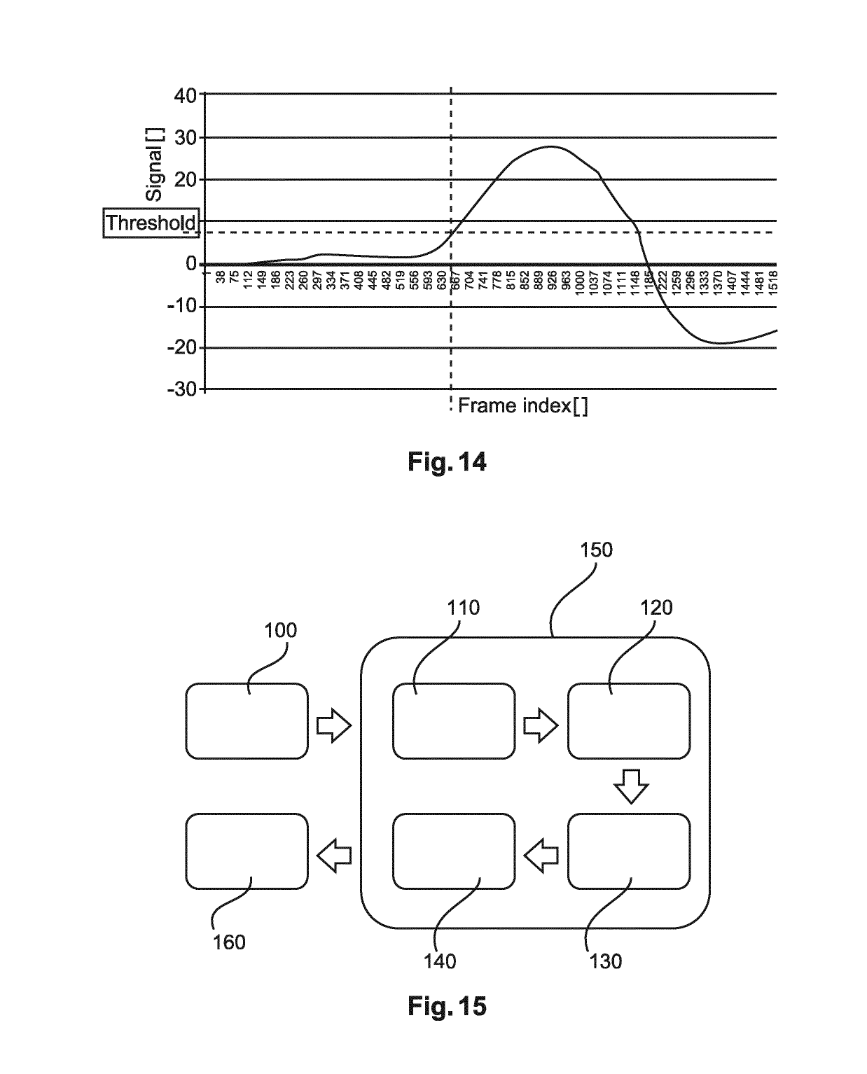

This filtering results in the line labeled “Step 1” of FIG. 12.

### Step 2: Calculate Trend

In the second step, more extreme smoothing of the signal was performed to get a prediction of the trend of the signal. This was done by filtering with a width of 333 frames (so

$$α = 1 - \frac{1}{333} = 0.997 ) .$$

This filtering results in line labeled “Step 2” in FIG. 12.

### Step 3: Calculate Trend Change

Subsequently, trend change was calculated by subtracting the trend from the smoothed signal. It was thus calculated how much the smoothed signal differs from the predicted signal. Expressed in a formula it could be obtained:

trend change=signalₛₘₒₒₜₕ−signal_{trend}

This subtraction results in the line labeled “Step 3” of FIG. 12.

### Example 7

### Threshold Signal

Threshold comparison was performed by a simple comparison of the signal after filtering with a fixed threshold. The frame index where the trend change signal is larger than the threshold is the moment of blob wetting detected. This is illustrated in FIG. 13. In the context of the present Example, the ideal threshold was found to be 7 based on image data with 8 bit precision. This value may be different in different technical contexts. For example, if a handheld analyzer has 10 bit precision this value must be multiplied by 4. Accordingly, the threshold to be used for such an analyzer may be 28.

### Example 8

### Matlab Reference Implementation

A framework was created in Matlab for developing, testing and tuning wetting algorithms (see FIG. 15).

The framework contains two main packages:
Wetting: this contains all importers, exporters, algorithms and entities
Wettingtest: this contains a set of testcases which generate data to be used for the verification of implementations based on the reference algorithm.

1. A method for evaluating the start of an assay in a fluidic chamber, wherein said start of the assay is based on the dissolving of a reagent in a region of interest in said fluidic chamber, wherein said dissolving causes an optical effect to occur in said region of interest, comprising the steps:
obtaining an optical signal from one or more sub-sections of said region of interest;
processing said optical signal to a Boolean signal according to the presence of said optical effect; and
defining the start of the assay based on said Boolean signal;
wherein said optical effect is a change in the refractive index of fluid due to the dissolving of said reagent in said region of interest, and wherein said change in the refractive index is recognizable as a charge of intensity towards an increased darkness in the region of interest.

2. The method of claim 1, wherein said step of processing the optical signal comprises
(i) normalizing said optical signal;
(ii) comparing the normalized signal of (i) with a threshold value, and
(iii) defining the start of the assay when said threshold value is surpassed.

3. The method of claim 1, wherein said reagent is sucrose.

4. The method of claim 1, wherein said assay is performed in the fluidic chamber of a microfluidic cartridge, preferably being part of an in-vitro diagnosis system.

5. The method of claim 1, wherein said region of interest is sub-divided into 3 or more overlapping sub-sections, preferably into a grid of 3×3 sub-sections, wherein preferably each two overlapping sectors show an overlap of at least 50%.

6. The method of claim 1, wherein said obtaining of an optical signal comprises recording of an frustrated total internal reflection image.

7. The method of claim 2, additionally comprising a step of removing spike signals subsequent to the step of obtaining an optical signal from a sub-section of a region of interest in which the assay is performed, preferably by using a median filter.

8. The method of claim 2, additionally comprising a step of combining signals subsequent to the step of normalizing said optical signal, wherein said combination of signals comprises a selection of the sub-section of the region of interest in which the highest signal is recorded per timeframe and a linking of these highest signals.

9. The method of claim 8, additionally comprising a step of calculating a trend change subsequent to the step of combining signals, wherein said calculation is based on a comparison of the combined signal with a smoothed version of the signal.

10. The method of claim 1, wherein said method comprises electrical detection of a change in the conductivity or permittivity of fluid due to the dissolving of said reagent.

11. The method of claim 1, wherein said definition of the start of the assay triggers the start of magnetic actuation in the fluidic chamber and/or of a measurement of assay results, preferably by optical detection such as FTIR imaging.

12. A program element or computer program for evaluating the start of an assay and optionally for triggering the start of magnetic actuation in the fluidic chamber and/or a measurement of assay results, which when being executed by a processor is adapted to carry out the optical signal processing steps, or adapted to carry out and/or control electrical detection of a change in the conductivity or permittivity of fluid of the method of claim 10.

13. An evaluation system for determining the start of an assay, comprising a computer processor, memory, and (a) data storage device(s), the memory having programming instructions to execute a program element or computer program according to claim 12.
